(19) United States
(12) Patent Application Publication
(10) Pub. No.: US 2007/0050379 A1
(43) Pub. Date: Mar. 1, 2007

(54) Highlighting entities in a display representation of a database query, results of a database query, and debug message of a database query to indicate associations

(75) Inventors: Paul Reuben Day, Rochester, MN (US); Brian Robert Muras, Rochester, MN (US)

Correspondence Address: WOOD, HERRON & EVANS, L.L.P. (IBM), 2700 CAREW TOWER, 441 VINE STREET, CINCINNATI, OH, 45202, US

(73) Assignee: International Business Machines Corporation, Armonk, NY (US)

(21) Appl. No.: 11/211,958

(22) Filed: Aug. 25, 2005

(51) Int. Cl. G06F 7/00

(52) U.S. Cl. 707/100

(57) ABSTRACT

An apparatus and method highlight entities in a display representation of a database query, result of a database query, and debug message of a database query to indicate associations, statistics, trends, and/or different groupings. Due to conventional techniques used to write database queries, display results of database queries, and the large number of messages in a job log or trace upon executing a database query, these may be confusing. However, highlighting may be applied to the display representations consistent with the invention to indicate associations, statistics, trends, and/or different groupings generally increasing productivity and decreasing human error.

### FIELD OF THE INVENTION

The invention relates to database management systems, and in particular, to the display of database queries, results of database queries, and debug message related to database queries.

### BACKGROUND OF THE INVENTION

Databases are used to store information for an innumerable number of applications, including various commercial, industrial, technical, scientific and educational applications. Databases are generally organized into tables and fields, and may be searched via database queries. A particular database may consist of many tables, and the tables in a database are generally related to each other.

A field is the smallest unit of information in a table. Generally, a table is an arrangement of data into columns and rows. A column is a vertical set of the same kind of fields (i.e., multiple data units under the same field name). The term field is also used to refer to a column. A row or record is a horizontal set of related fields. Generally, users interface with a table in a database by referencing the name of the field or identifier for the field. For example, a database query may be written to insert data into a field of a table and/or to search a field of a table.

Database queries are generally written in a human readable language such as Structured Query Language (SQL) to search databases. Database queries are generally input by developers and may include, for example, identifiers for tables and fields, operators (e.g., <, >, =, etc.) to be applied to the fields, and other values. Additionally, database queries may reference many tables and many fields which may lead to confusion. In particular, fields in a database query may be input with or without qualifying table information; therefore, it may be difficult to ascertain which fields belong to which tables from viewing the database query. For example, a third party, such as customer support, may be called upon to review and improve problematic database queries. In some instances, these queries may not include qualifying table information for each field identifier. Thus, the third party, who may not be familiar with the database query or the tables, and/or fields referenced thereby, may experience difficulty attempting to decipher the field and table relationships within the database query.

A need therefore exists in the art for an improved manner of displaying database queries, and in particular, an improved approach for displaying database queries that facilitates the understanding of field and table relationships that does not burden developers, database administrators, and/or other users.

Similar difficulties are also encountered in viewing results of an executed database query. For example, the results of a particular database query may contain tens to millions of records and/or columns. Thus, analyzing the results may be confusing, consume a lot of time, require additional labor, and/or may be prone to human error. Additionally, conventional application programs may only identify specific information incorporated into the logic of the application program and may therefore not identify other information in the displayed results a user may deem interesting such as which fields in the results of the database query belong to which tables of the database query, interesting trends, statistics, etc.

A need therefore exists in the art for an improved manner of displaying results of database queries, and in particular, an improved approach for displaying results of database queries that facilitates the identification of relationships and/or other analytical information that may be determined from the results.

Furthermore, similar difficulties are also encountered in viewing debug messages of an executed database query. For example, there may be tens to thousands of messages in a job log. Thus, identifying a message that references a table of a database query may generally be a difficult task as a user may have to “scroll” through the large number of messages to try to identify relevant messages. This approach may be unproductive and/or prone to human error.

A need therefore exists in the art for an improved manner of displaying debug messages, and in particular, an improved approach for displaying debug messages that facilitates the review of debug messages, thus, facilitating analysis, increasing productivity and/or reducing human error.

### BRIEF SUMMARY OF THE INVENTION

The invention addresses these and other problems associated with the prior art by providing in one aspect an apparatus and method that highlights identifiers for a field and a table in a display representation of a database query to indicate that the field and table represented by the identifiers are associated. Typically, identifiers may be highlighted to indicate an association between a field and table without explicitly altering the database query, often facilitating the understanding of field and table associations in spite of omitted qualifying information. Certain embodiments consistent with the invention may generate a display representation of a database query and highlight identifiers for a table and a field in the display representation of the database query to indicate that the field is associated with the table. Identifiers of another table and field(s) of the other table may be highlighted differently to indicate a different association Additionally, identifiers may be highlighted interactively during input of the database query in some embodiments.

Consistent with another aspect of the invention, a method highlights at least one field associated with a table of a database query in the display representation of results of the database query. Additionally, a statistic, a trend, and/or a portion of a group in a column that includes grouping and/or ordering may also be highlighted in the display representation of the result of the database query. Typically, the highlighting may be used to indicate associations between the fields in the results of a database query and the tables of the database query and identify a statistic, a trend, and/or a portion of a group in a column that includes grouping and/or ordering, often facilitating analysis of the results, increasing productivity, and/or reducing human error.

Consistent with yet another aspect of the invention, a method highlights an entity in a display representation of a debug message. An entity may be a literal value, a field identifier, a table identifier, an index, and/or an indication of a join order. Typically, the highlighting may be used to indicate that an entity specified in a debug message is associated with a parameter in a database query, often facilitating the identification of relevant debug messages, generally increasing productivity and/or reducing human error.

These and other advantages and features, which characterize the invention, are set forth in the claims annexed hereto and forming a further part hereof. However, for a better understanding of the invention, and of the advantages and objectives attained through its use, reference should be made to the drawings, and to the accompanying descriptive matter, in which there is described exemplary embodiments of the invention.

### BRIEF DESCRIPTION OF THE DRAWINGS

FIG. 1 is a block diagram of a networked computer system incorporating a database management system within which is implemented database highlighting consistent with the invention.

FIG. 2 is a block diagram illustrating the principal components and flow of information therebetween in the database management system of FIG. 1.

FIG. 3 is a flowchart illustrating the program flow of one implementation of a database query highlighting routine consistent with the invention.

FIG. 4 illustrates one example of highlighting a database query consistent with the invention.

FIG. 5 is a flowchart illustrating the program flow of one implementation of a result highlighting routine consistent with the invention.

FIG. 6A illustrates a database query for which a result may be highlighted consistent with the invention.

FIG. 6B illustrates one example of highlighting a result for the database query of FIG. 6A consistent with the invention.

FIG. 7 is a flowchart illustrating the program flow of one implementation of a database debug message highlighting routine consistent with the invention.

FIG. 8A illustrates a database query for which a debug message may be highlighted consistent with the invention.

FIG. 8B illustrates one example of highlighting a debug message for the database query of FIG. 8A consistent with the invention.

FIG. 8C illustrates another example of highlighting a debug message for the database query of FIG. 8A consistent with the invention.

### DETAILED DESCRIPTION

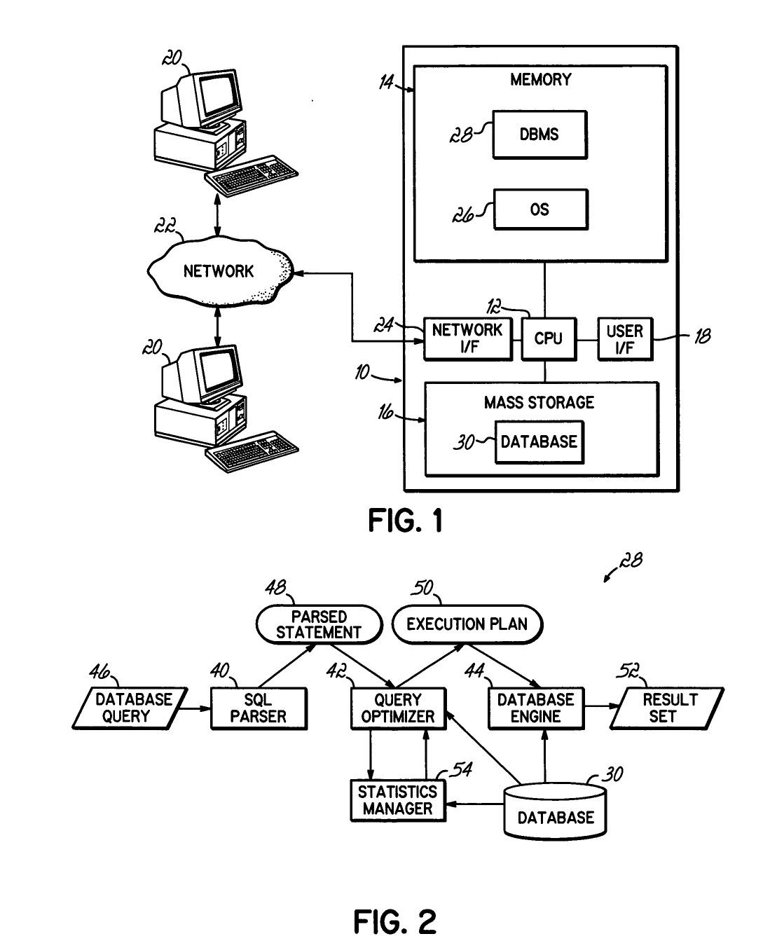

Turning now to the Drawings, wherein like numbers denote like parts throughout the several views, FIG. 1 illustrates an exemplary hardware and software environment for an apparatus 10 suitable for implementing a database management system consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated that the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., via a client or single-user computer 20 coupled to computer 10 over a network 22. This latter implementation may be desirable where computer 10 is implemented as a server or other form of multi-user computer. However, it should be appreciated that computer 10 may also be implemented as a standalone workstation, desktop, or other single-user computer in some embodiments.

For non-volatile storage, computer 10 typically includes one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 24 with one or more networks 22 (e.g., a LAN, a WAN, a wireless network, and/or the Internet, among others) to permit the communication of information with other computers and electronic devices. It should be appreciated that computer 10 typically includes suitable analog and/or digital interfaces between CPU 12 and each of components 14, 16, 18, and 24 as is well known in the art.

Computer 10 operates under the control of an operating system 26, and executes or otherwise relies upon various computer software applications, components, programs, objects, modules, data structures, etc. For example, a database management system (DBMS) 28 may be resident in memory 14 to access a database 30 resident in mass storage 16. Moreover, various applications, components, programs, objects, modules, etc. may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various computer readable media in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to fixed or removable recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

FIG. 2 next illustrates in greater detail the principal components in one implementation of DBMS 28. The principal components of DBMS 28 that are generally relevant to query execution are a Structured Query Language (SQL) parser 40, query optimizer 42 and database engine 44. SQL parser 40 receives from a user (or more typically, an application executed by that user) a database query 46, which in the illustrated embodiment, is provided in the form of an SQL statement. SQL parser 40 then generates a parsed statement 48 therefrom, which is passed to optimizer 42 for query optimization. As a result of query optimization, an execution or access plan 50 is generated. Once generated, the execution plan is forwarded to database engine 44 for execution of the database query on the information in database 30. The result of the execution of the database query is typically stored in a result set, as represented at block 52.

To facilitate the optimization of queries, the DBMS 28 may also include a statistics manager 54. Statistics manager 54 may be used to gather, create, and/or analyze statistical information using database 30 for query optimizer 42.

Generally, a DBMS consistent with the invention is able to highlight the display representation of a database query, display representation of results of a database query, and display representation of a debug message output of a database query. Generally, highlighting may be done in any manner know to those of ordinary skill in the art, such as including but not limited to applying at least one of a single color, multiple colors, oscillating color (e.g., using three colors over and over again such red, white, blue, red, white, blue, etc.), shading (e.g., variations of a single color, variations of multiple colors, a gradual change, etc.), a pattern (e.g., using three colors over and over again such red, white, blue, red, white, blue, etc. may be a pattern), a font, a font size, a style, an animation, an outline, an icon, etc. The same highlighting, similar highlighting, and/or any highlighting scheme may be used to indicate an association. Furthermore, a field consistent with the invention may be a single individual field and/or any set of fields (e.g., a vertical set of fields commonly referred to as a column, a horizontal set of fields commonly referred to as a row or record, fields in different rows, fields in different columns, etc). Therefore, highlighting may be applied to characters (e.g., the characters within a field, characters of an identifier, etc.), to a field (e.g., an entire field in the results of a database query including the characters, background, and lines of the square and/or rectangle encompassing the field, etc.), a part of a field (e.g., the background, the characters, the background and the characters, etc.), a set of fields, etc. A DBMS may also allow a user to select what should or shouldn't be highlighted, the specific highlighting to be used or not used, etc. Generally, the DBMS may be capable of any intelligent highlighting.

A DBMS consistent with the invention may be able to generate a display representation of a database query and/or highlight identifiers for fields and tables in the display representation of the database query to indicate an association between the fields and tables. Generally, a field may be associated with a table when the field belongs to the table. A DBMS may also be able to highlight interactively as a user inputs a database query. Additionally, a DBMS may also be able to automatically determine field and table associations and/or a user may indicate an association.

Additionally, a DBMS consistent with the invention may generate a display representation of at least a portion of a result of a database query and/or highlight a field in the results to indicate an association between the field and a table referenced in the database query. A field in the results may be associated with a table, for example, if the field in the result was derived from a field belonging to the table. A DBMS may also highlight a statistic, a trend, and/or a portion of a group in a column that includes grouping and/or ordering. For simplicity, these will be referred to as a feature of interest and/or features of interest in the detailed description and drawings. A DBMS may use any number of conventional techniques to identify a feature of interest. Additionally, in some embodiments, database software may be used to read the results of a database query and then apply highlighting logic before the results are displayed to a user.

A DBMS consistent with the invention may also generate a display representation of a debug message output of a database query and/or highlight an entity in the debug message to indicate an association with a parameter in the database query. A parameter in the database query may be a literal value, a field identifier, and a table identifier. An entity in a debug message may be associated with a parameter when the entity represents a literal value, a field identifier, and a table identifier found in the database query. Additionally, an entity may be associated with a parameter if the entity involves a table and/or field of the database query in practically any manner, for example, an entity may be an index referenced in the debug message to access a field of the database query, an indication of the join order of a field of a table of a database query, etc. A DBMS may also be able to highlight the display representation of the debug message to indicate an association with another debug message (e.g., debug messages are the same type, debug messages have the same date, etc.).

It will be appreciated by those of ordinary skill in the art, however, that optimizer 42, statistics manager 54, database 30, database engine 44, and/or other components may be accorded different functionality in some embodiments. Moreover, optimizer 42, statistics manager 54, database 30, database engine 44, and/or other components may be added and/or omitted in some embodiments. Those of ordinary skill in the art will also recognize that the exemplary implementation of DBMS 28 illustrated in FIG. 2 is not intended to limit the present invention. Indeed, those skilled in the art will recognize that other alternative hardware and/or software environments may be used without departing from the scope of the invention.

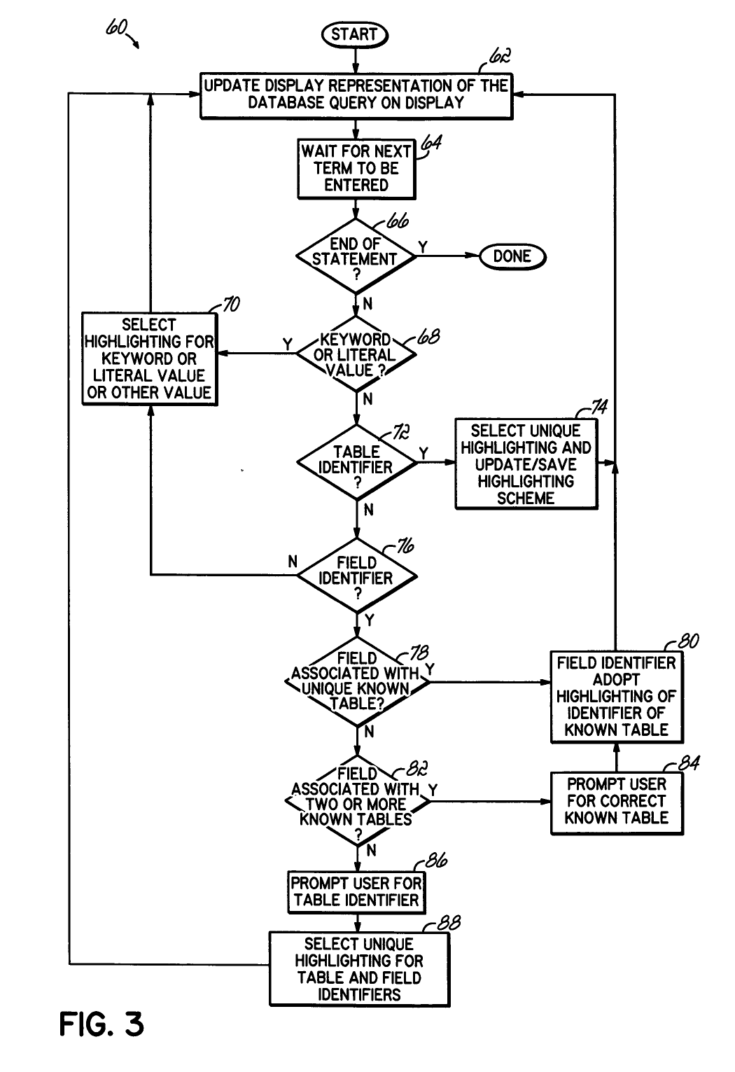

Turning now to FIG. 3, FIG. 3 illustrates an exemplary implementation of a database query highlighting routine 60 that interactively highlights identifiers for fields and tables in the display representation of the database query to indicate field and table associations. A field consistent with the invention may be a single field and/or any set of fields (e.g., a vertical set of fields commonly referred to as a column, a horizontal set of fields commonly referred to as a row or record, fields in different rows, fields in different columns, etc). Thus, an identifier for a field may identify at least one field.

Highlighting in routine 60 and other embodiments consistent with the invention may be done in any manner known to those of ordinary skill in the art, such as including but not limited to applying at least one of a single color, multiple colors, oscillating color, shading, a pattern, a font, a font size, a style, an animation, an outline, an icon, etc. The same highlighting, similar highlighting and/or any highlighting may be used to indicate an association. Furthermore, the highlighting scheme may be automatically chosen. However, in some embodiments, a user may be able to indicate the specific highlighting to be applied. For example, in some embodiments, a user may be able to indicate via his or her preferences desirable and/or undesirable highlighting. Additionally, in some embodiments, a user may be able to indicate (e.g., via his or her preferences) which identifiers may be highlighted and/or may not be highlighted. A user consistent with the invention may be practically anyone capable of issuing queries to a database management system, including, but not limited to a developer and/or a database administrator. Applications or other programs may also issue queries; thus, an application or other program may be considered a user consistent with the invention.

Starting at block 62 of routine 60, a display representation of a database query in a display (e.g., within a computer display, etc.) is updated with highlighting. The database query represented by the display representation may be practically any database query, and may include identifiers (e.g., identifier for a table or table identifier, identifier for a field or field identifier, etc.), keywords (e.g., SQL keywords such as select, from, where, group by, order by, etc.), literal values (e.g., 5 in the predicate table1.field1=5), operators (e.g., >, <, =, etc.), etc. Additionally, the query represented by the display representation may be input by a user via text input or via a graphical user interface (GUI). Furthermore, the database query may be loaded from non-volatile storage or may be a new database query.

Furthermore, the display representation of the database query may be displayed in any manner known to those of ordinary skill in the art. For example, practically any type of display such as a computer display, laptop, palmtop, PDA, mobile phone, etc. may be used to display the display representation of the database query. Additionally, the display representation of the database query may be within a web browser, a window, an editing tool such as those commonly used by developers to modify and/or test queries, a command line, etc. Thus, for example, as a command line is displayed on a computer display, the display representation of the database query within the command line is similarly displayed in the computer display. Additionally, the display representation of a database query may be displayed with other queries, text (including alphanumeric characters, non-alphanumeric characters, etc.), graphics, buttons, scrollbars, menus, etc.

Returning to block 62, typically the display representation of the database query will be updated with appropriate highlighting. The specific highlighting to be applied is discussed in more detail hereinbelow. Furthermore, as routine 60 highlights interactively, field and table identifiers may be interactively highlighted to indicate field and table associations while the user inputs the query.

Next, block 64 waits for the next term of the query statement to be input by the user. A term may be a word (e.g., a keyword, table identifier, field identifier, a combination of a table and field identifier, etc.), a value (e.g., 5 in a predicate such as table1.field1=5), punctuation (e.g., comma, semicolon, etc.), etc. However, the user may or may not input any data. Therefore, block 66 determines if the query statement (e.g., SQL statement) is complete.

In some embodiments, the presence of a semicolon may signal the statement is complete. Therefore, if the input of a user was a semicolon, this may signal the statement is complete, similarly completing routine 60. As routine 60 highlights interactively, when routine 60 completes, the display representation of the query will typically reflect field and table associations via the highlighted identifiers.

If the query statement is not complete (e.g., the user did not input a semicolon), then control passes to block 68. Block 68 determines whether a term input by the user is a keyword or literal value. A keyword may be any predefined word, for example, with respect to SQL, a keyword may be SELECT, FROM, WHERE, etc. A literal value may be any operand that is not a table or field identifier (e.g., 5 in a predicate such as table1.field1>5 or summer in a predicate such as table2.field2=‘summer’). If the term is a keyword or literal value, then, in block 70, highlighting is selected for the keyword or literal value. The highlighting selected for keywords and literal values may be different in some embodiments (e.g., a highlighting scheme for keywords may be red and bold whereas the highlighting scheme for literal values is blue and underlined), but the same highlighting may be used in some embodiments (e.g., highlighting set to keywords and literal values is black). Those of ordinary skill in the art may appreciate that some users may only want to highlight identifiers to indicate field and table associations and may not want keywords and literal values to stand out. Therefore, keywords and literal values may be highlighted the same in some embodiments, even though they are not associated, or not highlighted at all.

Next, control passes to block 62 and the display representation of the database query may be updated with any highlighting from block 70. Thus, a keyword or literal value input by the user may be updated in the display representation of the database query with the highlighting set in block 70, and routine 60 proceeds to block 64 to wait for additional input.

Returning to block 68, if the term input by the user is not a keyword or literal value, then block 72 determines if the term is a table identifier. For example, a term input after the SQL keyword “from” may be a table identifier. If the term is a table identifier, then a unique highlighting scheme may be chosen for the table identifier in block 74. The unique highlighting scheme may be saved (e.g., in an access plan) so that the same highlighting scheme may be applied to identifiers for fields that are associated with the table represented by the table identifier. Additionally, the highlighting scheme for the table identifier may also be updated, for example, a saved highlighting scheme from a previous execution of routine 60 may already be in use in a current execution of routine 60; therefore, a different highlighting scheme may be selected in block 74. Next, control passes to block 62 to update the table identifier with the highlighting, and continue as described above.

However, if the user did not input a table identifier, then control passes to block 76. Block 76 determines if the user input a field identifier. For example, a term input after the SQL keyword “select” may be a field identifier. Additionally, a term in a predicate following the SQL keyword “where” may also be a field identifier. However, if the term input by the user is not a field identifier (or a table identifier, a keyword, or literal value), then the term may be an operator (e.g., <, >, =, etc.) and/or any other value. Thus, control passes to block 70 to select highlighting for that term in any manner such as those mentioned above in connection with highlighting keywords and/or literal values.

If a field identifier was input by the user, then block 78 determines if only one known table has a field that may be represented by the field identifier. A table may be known when a table identifier representing that table was input during a previous iteration of routine 60 (e.g., in connection with block 72 and 74). As an example, if there are three known tables (e.g., the user input three table identifiers such as table1, table2, and table3) and only the table represented by table identifier table3 has an employerID field that may be represented by field identifier employerID, then the highlighting of the field identifier employerID may be automatically set to the highlighting of table identifier table3 in block 80. Next, control passes to block 62 to update the field identifier with the highlighting, and continue as described above. In some embodiments, the same highlighting may be selected, however, the same highlighting need not be selected to indicate an association in some embodiments. For example, if the table identifier is highlighted in a red color, an associated field identifier may be highlighted in a lighter shade of red, or the same red color as the table identifier but with underlining. Thus, an association may still be indicated even though the same highlighting is not selected.

Returning back to block 78, the user may input an identifier for a field that matches an identifier for at least one other field of the known tables (i.e., more than one known table has a field that may be represented by the field identifier). Often times, different tables may have fields with the same name; thus, the same field identifier may be used to identify all of these fields. For example, tableA may have an employeeID field, tableB may have an employeeID field, and tableC may have an employeeID field. Therefore, if the user inputs field identifier employeeID without qualifying table information, it is usually unknown whether field identifier employeeID refers to the employeefield of table A, B, or C. Thus, in block 82, if a field is associated with two or more known tables, then control passes to block 84 to prompt the user for the correct known table. In some embodiments, field identifiers may be displayed in the display representation of the database query in the highlighting of the identifiers of the known tables containing fields that may be represented by the field identifier, and the user may choose from the displayed field identifiers based on the highlighting. For example, if the identifier of tableA is red, the identifier of tableB is green, and the identifier of tableC is blue, all three tables have an employeeID field, and the user inputs the field identifier employeeID, then three employeeID identifiers may be displayed, one highlighted in red, a second in green and a third in blue for the user to select. One of these highlighted identifiers may be the one input by the user. Thus, if the user was referring to the field of tableB, the user may choose the field identifier employeeID with the same highlighting of the identifier of tableB, mainly green highlighting, and the field identifier may adopt the highlighting of the known table the user selected in block 80.

Additionally, in some embodiments, the selection may partially be done automatically. As an example, a database query may only have two tables that contain employeeID fields, tableA and tableB, and a user may input the following predicate: employeeID=employeeID. Therefore, after a user inputs the first field identifier and selects the known table associated with the first employeeID field, upon entering the second field identifier, in some embodiments the user may not be prompted again, instead the highlighting of the second employeeID may be set to the highlighting of the identifier for the remaining known table. Next, control passes to block 62 to update the field identifier with the highlighting, and continue as described above.

Returning to block 82, none of the known tables may have a field that can be represented by the field identifier input by the user. For example, such may be the case if the user has not input any table identifiers. Typically, with respect to SQL, a user inputs field identifiers first, which may not include any qualifying table information, and afterwards, the user may input the table identifiers. As routine 60 highlights interactively while the user inputs the database query and the user may not have input any table identifiers yet, there may not be any known tables associated with a field that may be represented by the field identifier input by the user. Therefore, in block 86, the user may be prompted for at least one table identifier and the user may input an identifier for a table associated with the field of the field identifier (i.e., table represented by table identifier contains the field represented by the field identifier). Next, in block 88, a unique highlighting scheme may be selected for the table identifier and the field identifier. Next, control passes to block 62 to update the identifiers with the highlighting, and continue as described above.

Alternatively, in some embodiments, in block 86, a user may be prompted to input table identifiers for all tables to be used to execute the database query. Thus, a unique highlighting scheme may be similarly selected for each table identifier. Next, instead of passing control to block 88, control returns to back to block 78 to determine if the field identifier input by the user is associated with only one known table (block 78) or two or more known tables (block 82). Those of ordinary skill in the art may appreciate that by providing all the table identifiers for all the tables to be used by the database query, these tables will be known tables in future iterations. Furthermore, because users that input database queries using SQL typically input field identifiers first, this alternative approach may be favored and does not necessarily burden users as SQL users will generally have to input table identifiers for all the tables in the database query, albeit later in the database query. With this alternative implementation, control may similarly pass to block 62 to update the display representation with the highlighting, and continue as described above.

Additionally, regardless of the implementation, a portion of the result of the database query may be highlighted to indicate an association (e.g., field in result is derived from a table in the database query) with an identifier (e.g., field and/or table identifier) in the database query after the user inputs the whole statement.

The following example illustrates the advantages of the illustrated embodiments. Table I below, for example, illustrates a database query.

TABLE I

| | |
|---|---|
| query1: | select month(dates), sum(sales), |
| | from fact_table , time_dim , price_dim |
| | where tid = timeid and pid = priceid |
| | group by month(dates) |
| | order by sum(sales) |

It should be noted that, without highlighting, it may be difficult for one unfamiliar with the tables (i.e., fact_table, time_dim, and price_dim) and fields (i.e., dates, sales, tid, timeid, pid, priceid) referenced in query1 to ascertain which fields are associated with which tables. For example, due to the naming convention, it is possible that either pid or priceid represents a field in the price_dim table. However, it is unclear as to whether pid or priceid is a field in the price_dim table. Similar confusion may also be experienced with respect to the remaining field identifiers.

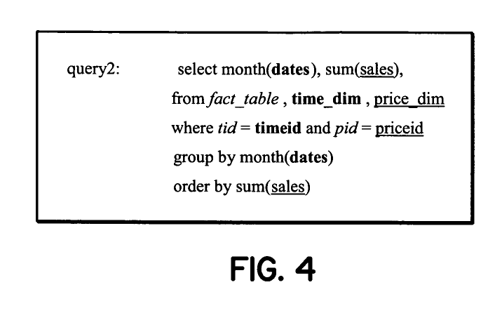

On the other hand, consistent with the invention, highlighting schemes may be applied to the table identifiers and field identifiers as illustrated in FIG. 4 to indicate field and table associations. Thus, a user, viewing a display representation with the highlighting illustrated in FIG. 4, may be able to determine that the tid field and pid field are associated with the fact_table because the identifiers for each are displayed in italics. Moreover, the tid field is not associated with the time_dim table because the identifier for the tid field is displayed in italics and not in bold as the identifier for the time_dim table. Similarly, a user may be able to ascertain that the dates field and the timeid field are associated with the time_dim table because identifiers for each are displayed in bold, and the sales field and priceid field are associated with the price_dim table because identifiers for each are displayed with underlining.

The illustrated embodiments offer a number of benefits. For example, users may continue to input field identifiers without any qualifying table information saving time and labor, and yet, the qualifying information may be displayed via the highlighting without explicitly changing the database query in the display representation of the database query. Thus, users can view the display representation of the database query and see the field and table associations via the highlighted identifiers. Furthermore, the user may not need to remember whether only one table, two, or more than two tables are associated with a particular field because the field identifier may automatically be updated with the highlighting of the associated table and/or a field identifier may be displayed in the highlighting of each table identifier (e.g., where the table represented by the table identifier contains a field that may be represented by the field identifier) and the user may be prompted to make a selection. Thus, in certain circumstances, users may not need to recall which table or tables contain a certain field while inputting the database query.

Moreover, in some embodiments, the number of ambiguous reference errors may be reduced. As long as only one table in a database query contains a particular field, the omitted qualifying table information generally does not affect the execution of a query. But, when more than one table in the query is associated with the field and no qualifying table information has been included with the field identifier, ambiguous reference errors typically result. However, as the qualifying table information may be indicated via the highlighting, those of ordinary skill in the art may appreciate that this may result in fewer ambiguous reference errors and an increase in productivity.

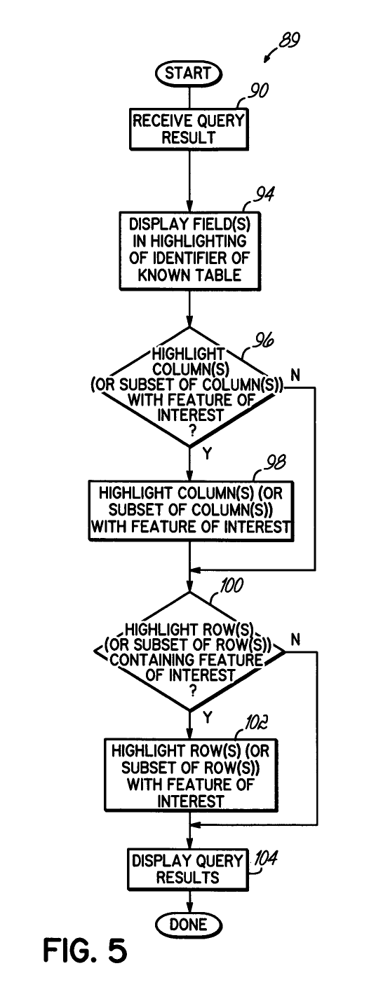

Turning now to FIG. 5, FIG. 5 illustrates an exemplary implementation of a result highlighting routine 89 that highlights at least one field in the display representation of a result of a database query to indicate the field is associated with a table of the database query. A field consistent with the invention may be a single field and/or any set of fields (e.g., a vertical set of fields commonly referred to as a column, a horizontal set of fields commonly referred to as a row or record, fields in different rows, fields in different columns, etc). Additionally, a feature of interest may also be highlighted in the display representation of the results. Any technique known in the art may be used to identify a feature of interest. Furthermore, these features may be highlighted in at least one field (e.g., single individual field), at least one column, at least one row, at least one subset of a column, and/or at least one subset of a row of the result in the display representation of the result of the database query.

Highlighting in routine 89 and other embodiments consistent with the invention may be done in any manner know to those of ordinary skill in the art, such as including but not limited to applying at least one of a single color, multiple colors, oscillating color, shading, a pattern, a font, a font size, a style, an animation, an outline, an icon, etc. The same highlighting, similar highlighting and/or any highlighting may be used to indicate an association. Moreover, the characters within a field and/or a whole field may be highlighted consistent with the invention. Furthermore, the highlighting scheme may be automatically chosen, however, in some embodiments, a user may be able to indicate the specific highlighting to be applied. For example, a user may set his or her preferences to indicate desirable and/or undesirable highlighting. In some embodiments, users may be able to indicate (e.g., via their preferences) which field(s) and/or feature(s) of interest should be highlighted and/or not highlighted. A user consistent with the invention may be practically anyone capable of issuing queries to a database management system, including a developer and/or a database administrator. Applications or other programs may also issue queries; thus, an application or other program may be considered a user consistent with the invention.

Starting with block 90, the results of a database query are received. Typically, at block 90, a user has already input the database query and a database engine has finished executing the database query. Those of ordinary skill in the art may appreciate that block 94 may incorporate routine 60 in FIG. 3, however, such need not be the case in some embodiments. In block 94 at least one field in the results of the database query is displayed in the highlighting of the identifier of the known table associated with the field. Therefore, if the identifier of the known table associated with the field is highlighted in pink, the field may be highlighted in pink in the display representation of the results. A feature of interest may be highlighted. The display representation of results may be displayed in any manner known in the art. For example, practically any type of display such as a computer display, laptop, palmtop, PDA, mobile phone, etc. may be used to display the display representation of the result of a database query. The display representation of the result may also be within a web browser, a window, an editing tool, etc.

Those of ordinary skill in the art may appreciate the benefit of such highlighting. For example, if a display representation of results of a database query displayed twenty columns, users may be able to easily determine which fields belong to which tables referenced in the database query based upon the highlighting scheme of the field. The same highlighting may be used to indicate an association, however, the same highlighting need not be selected to indicate an association in some embodiments. For example, if the table identifier is highlighted in a red color, an associated field may be highlighted in a lighter shade of red, or the same red color as the table identifier but bold. Thus, an association may still be indicated even though the same highlighting is not selected.

Although routine 60 in FIG. 3 may be used when a user initially inputs a database query and routine 89 may be used for the results, in some embodiments, routine 89 may be used without routine 60. For example, a certain highlighting scheme may be saved and/or only used for an identifier of a specific table; thus, fields of that table may be displayed in that highlighting scheme in the display representation of results even if routine 60 is not used to interactively highlight the display representation of the database query containing the table identifier. Alternatively, a highlighting scheme may temporarily be applied to an identifier of a table, and that highlighting scheme may be used to highlight a field of the table in the display representation of the result of the database query.

Next, control passes to block 96. Block 96 determines whether or not to highlight at least one column and/or subset of a column with a feature of interest. A feature of interest may be a statistic, trend, and/or a portion of a group in a column with grouping and/or ordering. A statistic may be a minimum value, a maximum value, a mean value, a value within one standard deviation of another value, a value within two standard deviations of another value, a value within N standard deviations of another value, etc.

A trend may be a direction in the data values (e.g., a progression from a minimum value to a maximum value, a progression from a maximum to a minimum value, etc.), etc. A trend may be in a single column, a set of columns, across the entire result of a database query (e.g., progression from the first row in the result to the last row in the result), etc. In particular, the highlighting applied to a trend should be indicative of the relative (e.g., general position) position of data within the trend. Shading may be applied, sections may be highlighted, and/or any other highlighting indicative of the relative position of data within a trend may be used. As an example, a column may have fields with values increasing from 1 to 100. Thus, 1 may be highlighted in a light shade of green, the shade of green may become darker from 2 to 99, with the darkest shade of green applied to 100. Alternatively, any other highlighting scheme may be used to indicate the relative location of data in a trend such as highlighting by sections (e.g., according to a color wheel). Using the same example, the first ten fields out of the hundred in the column may be highlighted in yellow, the second ten fields may be highlighted in orange, the third ten may be highlighted in red, etc. Thus, a similar increasing affect may be accomplished. Those of ordinary skill in the art may appreciate that by looking at the highlighting, for example, the user may be able to determine the relative location of the data within a trend upon viewing a display representation of the result.

Next, at least one group or subset of a group may be highlighted to indicate a difference with another group. A group may be different from another group in a column which includes grouping and/or ordering based upon practically any difference or change (e.g., different values among two groups, etc.). A group may be of one or more identical values. In some embodiments, a group may be one or more similar values. As an example, a first group in a column may contain ten fields with the value Minnesota, and then, a different group with fields containing the value New York may be in the column. There may be twenty fields with the value New York and then a different value such as Wyoming may appear in the column. Therefore, all fields containing the Minnesota values may be highlighted in green, the next twenty fields consisting of New York values may be highlighted in pink to indicate a different group, and the next group of fields containing a different value may be highlighted in red to indicate another group.

Alternatively, less than all fields in a group may be highlighted to indicate a difference. For example, in some embodiments only the first value of a group may be highlighted to indicate a different group; thus, the first Minnesota value may be highlighted in green, the first New York value may be highlighted in pink, and the first Wyoming value may be highlighted in red. Furthermore, the highlighting of the different groups in a column may be carried over to another column (e.g., column with different values). For example, the ten fields in the column to the right of the fields containing Minnesota may also be highlighted in green, the twenty fields to the right of the fields containing New York may be highlighted in pink, and so forth. Those of ordinary skill in the art may appreciate that by using the same highlighting on another column, for example a column with cities, the highlighting may indicate that the states and cities that are highlighted alike are associated.

Returning to block 96, users may vary as to whether or not features of interest should be displayed in columns of the display representation of the results. Thus, in some embodiments, if the user's preferences indicate the user wants features of interest displayed, then in block 98, the features of interest may be highlighted in at least one column or subset of a column (e.g., a field, two fields, etc.) when the results of the query are displayed.

Next, control passes to block 100. Block 100 determines whether or not to highlight a least one row and/or subset of a row containing a feature of interest in the display representation of results of a database query. As mentioned above in connection with block 96, users may vary as to whether a feature of interest should be highlighted in rows of the display representation of the results; thus, in some embodiments, a user's preferences may be used in making this determination. In block 102, a feature of interest may be highlighted in at least one row and/or subset of a row in the results.

Next, control passes to block 104 to display the query results. The query results may be displayed in any manner known to those of ordinary skill in the art. In displaying the display representation of the results, fields may be displayed in the highlighting of the identifiers of known tables associated with the fields, features of interest may be highlighted in columns and/or subsets of columns, and/or features of interest may be highlighted in rows and/or subsets of rows. This completes the exemplary implementation of routine 89 in FIG. 5.

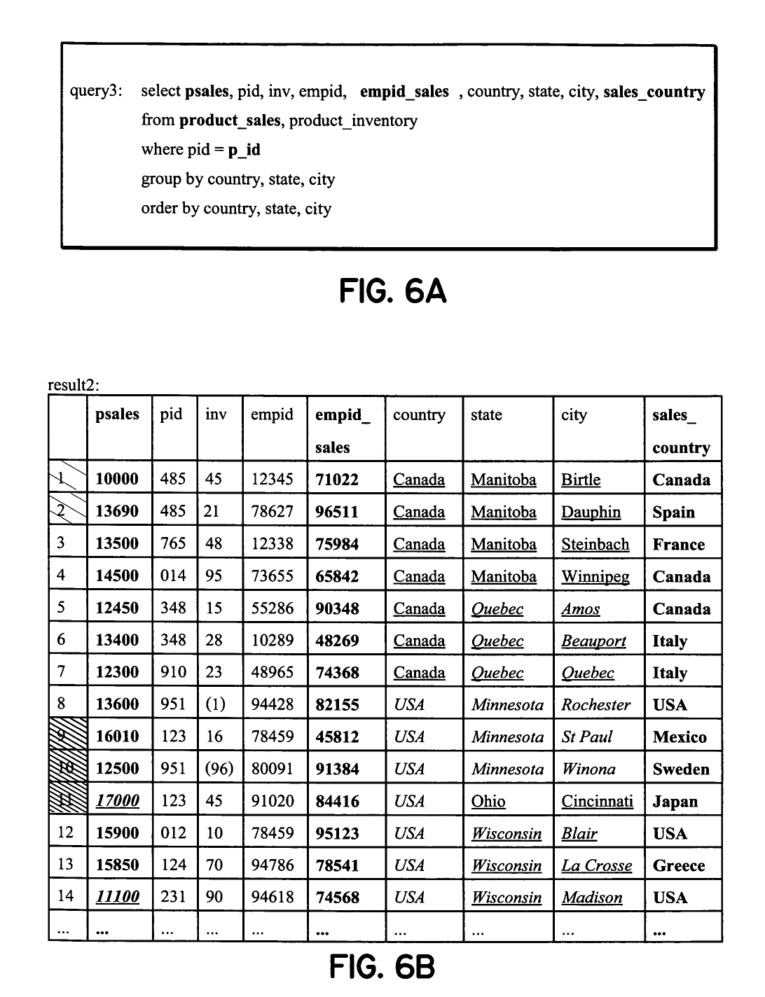

The following example illustrates the advantages of the illustrated embodiments. In this example, a query3 with the highlighting illustrated in FIG. 6A or without any highlighting may be executed. Field psales is the sales of the product, pid is the identification number of the product, inv is the quantity of the product in inventory, empid is the identification number of the employee in charge of manufacturing and inventory of the product, empid_sales is the identification number of the employee in charge of selling the product, country is the country where the product is manufactured, state is the state where the product is manufactured, city is the city where the product is manufactured, and sales_country is the country where the product is sold.

Using conventional techniques, the results of query3 may be displayed as in results2 in FIG. 6B without any highlighting. Thus, determining which fields are associated with the product_inventory table, for example, instead of the product_sales table, may be confusing. Furthermore, identifying features of interest such as the lowest inventory quantity is 1 and the highest is 96 may also be confusing. Instead of only fifteen records, a result of a query may yield tens to millions of records and/or columns, further increasing the difficulty. Moreover, a database query may reference more than two tables.

On the other hand, consistent with the invention, the results of query3 may be displayed with the highlighting illustrated in results2 in FIG. 6B. Therefore, via the bold highlighting scheme, a user may be able to see that the psales, empid_sales, and sales_country columns are fields associated with the same table, mainly the product_sales table whose identifier may be displayed in bold using routine 60. As query3 only references two tables, a user may be able to determine that the columns not highlighted in bold in result2 are therefore associated with the product_inventory table.

Features of interest are also highlighted in result2 in FIG. 6B, e.g., highlighting was used to indicate that the minimum quantity in inventory is 1 and the maximum quantity is 96, the minimum sale amount is 11100 and the maximum sale amount is 17000, etc. The minimum and maximum values may be useful, for example, because some of the inventory of product 951, for which there is a quantity of 96 available, may be used to compensate for the low inventory quantity of 1, especially because all of product 951 is manufactured in Minnesota as indicated by the highlighting of like values in the city column. Additionally, different groups in the country, state and city columns are illustrated via the oscillating highlighting scheme. Specifically, Manitoba fields are underlined, Quebec fields are underlined and in italics, Minnesota fields are in italics, etc. Furthermore, the same highlighting scheme of the state column is applied to the city column to indicate that the cities are associated with the states to the left. Furthermore, the trend in the row number column is shaded. Thus, by the shading, a user may be able to determine the relative position of the data in the row number column.

Those of ordinary skill in the art may appreciate the benefits of highlighting the display representation of results of a database query. For example, in addition to the actual results, additional information may be displayed without a user having to execute additional queries. Furthermore, a user may learn something about the results that may help in future iterations of the database query.

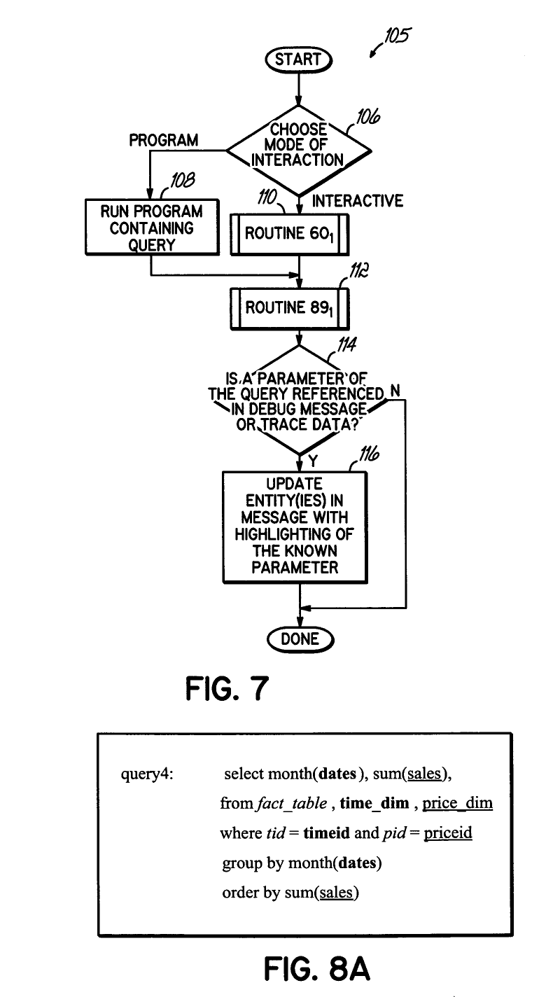

Turning now to FIG. 7, FIG. 7 illustrates an exemplary implementation of a database debug message highlighting routine 89 that highlights at least one entity in the display representation of the debug message output to indicate an association with a parameter in a database query. A parameter may be a literal value (e.g., the 5 in column1=5), a field identifier, and/or a table identifier. An entity may be associated with a parameter of a database query when the entity is the parameter (e.g., a table identifier in a database query is also in a debug message, a field identifier in a database query is also in a debug message, a literal value in a database query is also in a debug message, etc.) and/or related to a table and/or field of the database query (e.g., an identifier for an index in a debug message used to access a table and/or field of a table of the database query, an indication of a join order in a debug message used to join a table and/or field of a table in the database query, etc.). In some embodiments, a user may be able to indicate which entities are highlighted and/or not highlighted.

Additionally, a field consistent with the invention may be a single field and/or any set of fields (e.g., a vertical set of fields commonly referred to as a column, a horizontal set of fields commonly referred to as a row or record, fields in different rows, fields in different columns, etc). Thus, an identifier for a field may identify at least one field. A debug message may be practically any message capable of assisting a user with debugging. Thus, a debug message consistent with the invention may also be data in a trace.

Highlighting in routine 105 and other embodiments consistent with the invention may be done in any manner known to those of ordinary skill in the art, such as including but not limited to applying one of a single color, multiple colors, oscillating color, shading, a pattern, a font, a font size, a style, an animation, an outline, an icon, etc. The same highlighting, similar highlighting and/or any highlighting may be used to indicate an association. Furthermore, the highlighting scheme may be automatically chosen, however, in some embodiments, a user may be able to indicate the specific highlighting to be applied. For example, a user may set his or her preferences to indicate desirable and/or undesirable highlighting. Additionally, in some embodiments, the user may be able to indicate (e.g., via their preferences) which entities should be highlighted and/or not highlighted. A user consistent with the invention may be practically anyone capable of issuing queries to a database management system, including a developer and/or a database administrator. Applications or other programs may also issue queries; thus, an application or other program may be considered a user consistent with the invention.

Those of ordinary skill in the art may appreciate that routine 105 may incorporate routine 60 in FIG. 3 and/or routine 89 in FIG. 5. However, such need not be the case in some embodiments. Starting with block 106, the mode of interaction may be determined. The mode of interaction chosen, for example, may be based upon a user's preferences. In block 108, there may be a program mode of interaction and the program containing a database query may be executed. On the other hand, as in block 110, the mode of interaction may be interactive and routine 60 may be called to interactively highlight identifiers in the display representation of the database query as the user inputs the query. Similarly, the database query may be executed after the user has input the database query. Next, control passes to block 112, which calls upon routine 89 to display the display representation of the result of the database query.

Then, block 114 determines whether a parameter of the database query is referenced in at least one debug message and/or trace data. If not, then routine 105 completes. On the other hand, if a parameter of the database query is referenced in a debug message, for example, the debug message contains a literal value, field identifier, table identifier, and/or any other information associated with a parameter of the query (e.g., index, indication of a join order, etc.) then any such entities in the display representation of the debug message or trace data output may be updated with the highlighting of the known parameter associated with the entity in block 116. Thus, for example, if an identifier of a table was highlighted in green and italics in the display representation of the database query in routine 60 and the same table identifier is referenced in a debug message, the table identifier in the display representation of the debug message output may be highlighted in green and italics to indicate an association between the table identifier in the debug message and the identifier of the known table in the database query. The display representation of the debug message output may be displayed in any manner known in the art. For example, practically any type of display such as a computer display, laptop, palmtop, PDA, mobile phone, etc. may be used to display the display representation of the result of a database query. The display representation of the result may also be within a web browser, a window, an editing tool, etc.

Similarly, an index and/or indication of the join order in the display representation of a debug message or trace data may be highlighted with the highlighting of the identifier of the associated known parameter (e.g., field identifier and/or table identifier). The highlighting of routine 60 may be used to indicate associations, on the other hand, if routine 60 was not implemented in routine 105, for example, a saved highlighting scheme may be used and/or a highlighting scheme reserved for an identifier of a specific table may be used. Thus, identifiers for the table, identifiers for the fields of the table, and/or any other associated entity (i.e., associated with the table and/or field of the table) may be displayed in that highlighting scheme of the identifier of the table and/or field of the table in the display representation of the debug message even if routine 60 is not used. Furthermore, in some embodiments, the same highlighting may be selected, however, the same highlighting need not be selected to indicate an association in some embodiments. For example, if a known parameter (e.g., a table identifier) is highlighted in a red color in the display representation of the database query, an associated table identifier (e.g., the same table identifier in the debug message) may be highlighted in a lighter shade of red, or the same red color as the table identifier but bold. Thus, an association may still be indicated even though the same highlighting is not selected. Additionally, in some embodiments the display representation of the debug message may also be highlighted to indicate an association with another debug message.

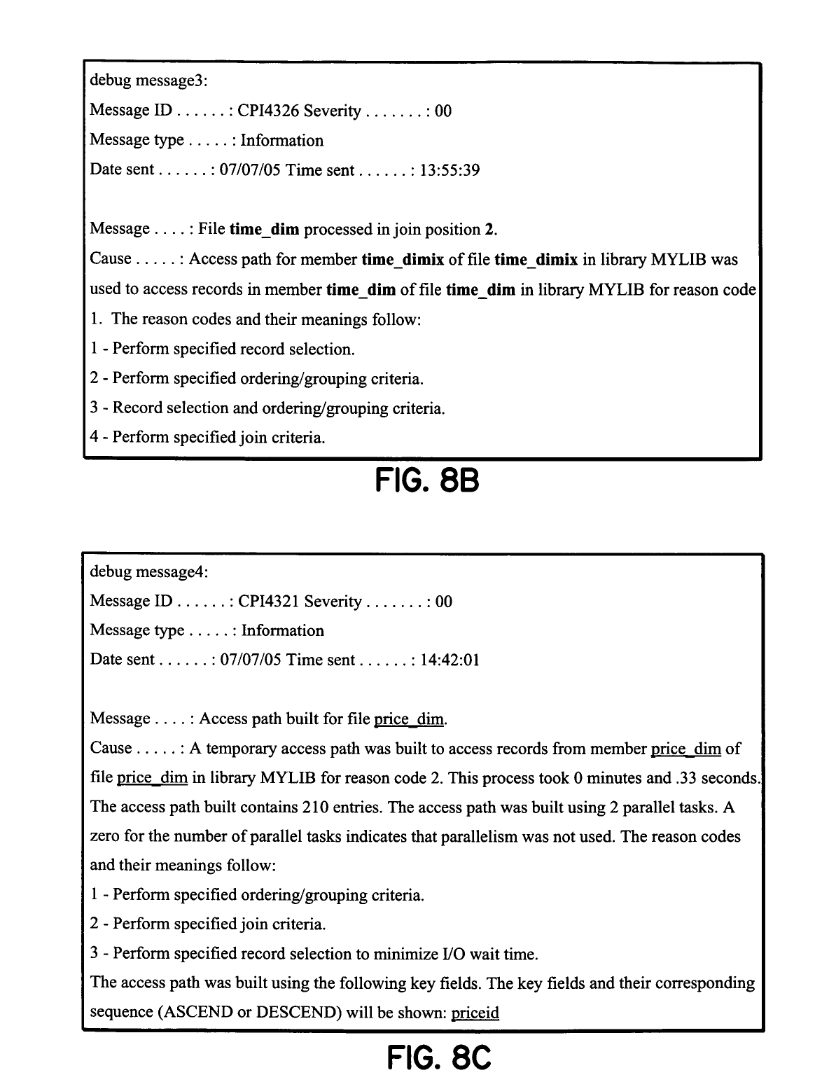

The following example illustrates the advantages of the illustrated embodiments. In this example, a query4 with the highlighting illustrated in FIG. 8A or without the highlighting may be executed. Upon execution, conventional techniques may display debug message3 in FIG. 8B and debug message4 in FIG. 8C without the highlighting. However, upon viewing a display representation of the debug message3 and debug message4 without highlighting, it may be difficult to identify entities in the debug messages associated with the fact_table, time_dim, and/or price_dim tables. Typically, the more debug messages, the greater the difficulty.

On the other hand, consistent with the invention, the debug messages may be displayed as illustrated in FIGS. 8B and 8C. Therefore, entities in the debug message3 and debug message4 associated with a table of query4 may be highlighted in the display representation of the debug messages to indicate an association. In particular, the entities time_dim, price_dim, and priceid are all highlighted in the debug messages to indicate an association with tables of query4, mainly the time_dim is highlighted in bold to indicate an association with the time_dim table in query4 and the price_dim and priceid are underlined to indicate an association with the price_dim table of query4. Additionally, the reference to index time_dimix and join position 2 are also highlighted in bold to indicate an association with the time_dim table. Those of ordinary skill in the art may appreciate that highlighting entities in the display representation of a debug message may reduce confusion, increase productivity and/or reduce human error.

Various modifications may be made to the illustrated embodiments without departing from the spirit and scope of the invention. Therefore, the invention lies in the claims hereinafter appended.

What is claimed is:

1. A method of displaying a database query, the method comprising:
(a) generating a display representation of a database query, the database query specifying first and second tables and a field of the first table; and
(b) highlighting identifiers for the first table and field in the display representation of the database query to indicate that the field is associated with the first table rather than the second table.

2. The method of claim 1, further comprising applying different highlighting in the display representation of the database query for identifiers of another table and field in the other table specified in the database query to indicate a different field and table association.

3. The method of claim 1, wherein highlighting the identifiers is performed interactively during input of the database query by a user.

4. The method of claim 1, wherein the field has an identifier matching a second field of a second table, the method further comprising displaying in the display representation of the database query the identifier in the highlighting of the identifier for the first table and displaying a second identical identifier in the highlighting of the identifier for the second table.

5. The method of claim 1, wherein the field has an identifier matching a second field of a second table, the method further comprising determining that the identifier for the field is associated with the first field rather than the second-field.

6. The method of claim 5, wherein determining whether a field is associated with a table is based upon at least one of a user selection or an automated selection.

7. The method of claim 1, wherein highlighting includes applying at least one of a single color, multiple colors, oscillating color, shading, a pattern, a font, a font size, a style, an animation, an outline, or an icon.

8. A method of displaying a result of a database query, the method comprising:
(a) generating a display representation of at least a portion of a result of a database query in response to execution of the database query, the display representation of the result of the database query identifying a field; and
(b) highlighting the field in the display representation of the result of the database query to indicate the field is associated with a table specified in the database query.

9. The method of claim 8, further comprising highlighting a statistic in the display representation of the result of the database query.

10. The method of claim 8, further comprising highlighting a trend in the display representation of the result of the database query using highlighting to indicate the relative position of result data within the trend.

11. The method of claim 8, wherein in a column of the result has at least one of a grouping or an ordering criteria, the method further comprising highlighting at least a portion of a first group in the display representation of the result of the database query to indicate a difference between the first group in the column and a second group in the column.

12. A method of displaying a debug message, the method comprising:
(a) generating a display representation of a debug message output as a result of execution of a database query, the debug message output identifying an entity; and
(b) highlighting the entity in the display representation of the debug message to indicate that the entity specified in the debug message is associated with a parameter of the database query.

13. The method of claim 12, wherein the parameter is at least one of a literal value, an identifier for a field, or an identifier for a table.

14. The method of claim 12, wherein the entity includes at least one of a literal value, an identifier of a table, an identifier of a field, an index, or an indication of a join order.

15. The method of claim 12, wherein indicating that the entity specified in the debug message is associated with the parameter includes highlighting the entity in the display representation of the result using the highlighting of the parameter that is associated with the entity.

16. The method of claim 12, further comprising providing a user with at least one option of selecting the highlighting to be applied to the entity, selecting which entities should be highlighted, or highlighting the display representation of the debug message to indicate an association with another debug message.

17. An apparatus, comprising:
(a) computer readable medium; and
(b) program code resident in the computer readable medium and configured to display a database query, the program code configured to generate a display representation of a database query, that specifies first and second tables and a field of the first table, and highlight identifiers for the first table and field in the display representation of the database query to indicate that the field is associated with the first table rather than the second table.

18. The apparatus of claim 17, wherein the program code is further configured to apply different highlighting in the display representation of the database query for identifiers of another table and field in the other table specified in the database query to indicate a different field and table association.

19. The apparatus of claim 17, wherein the program code is further configured to highlight the identifiers interactively during input of the database query by a user.

20. The apparatus of claim 17, wherein the program code is further configured to display in the display representation of the database query the identifier in the highlighting of the identifier for the first table and display a second identical identifier in the highlighting of an identifier for the second table.

21. The apparatus of claim 17, wherein the program code is further configured to determine that the field identifier is associated with the first field rather than the second field.

22. The apparatus of claim 17, wherein the program code is further configured to determine whether a field is associated with a table based upon at least one of a user selection or an automated selection.

23. The apparatus of claim 17, wherein highlighting includes applying at least one of a single color, multiple colors, oscillating color, shading, a pattern, a font, a font size, a style, an animation, an outline, or an icon.

24. The apparatus of claim 17, further comprising at least one processor coupled to the computer readable medium and configured to execute the program code.

25. The apparatus of claim 17, wherein the computer readable medium is a removable medium configured to be installed in a computer for execution of the program code in the computer.
